(19) United States
(12) Patent Application Publication
(10) Pub. No.: US 2013/0218890 A1
(43) Pub. Date: Aug. 22, 2013

(54) GEOGRAPHIC ASSET MANAGEMENT SYSTEM

(71) Applicants: James Conal Fernandes, Victoria (CA); Karl Alexander Swannie, Victoria (CA); Devon Walter Greenway, Victoria (CA)

(72) Inventors: James Conal Fernandes, Victoria (CA); Karl Alexander Swannie, Victoria (CA); Devon Walter Greenway, Victoria (CA)

(21) Appl. No.: 13/596,375

(22) Filed: Aug. 28, 2012

Related U.S. Application Data
(60) Provisional application No. 61/528,748, filed on Aug. 29, 2011.

(51) Int. Cl. G06F 17/30

(52) U.S. Cl. CPC G06F 17/30283
USPC 707/736

(57) ABSTRACT

A geographic asset management system, in which assets such as buildings, permits and grants are tagged with geographical locations for display on a geographical information subsystem forming a component of the system. In an asset management subsystem, assets may be selected, analyzed or edited according to a user's permission level. Physical assets may be represented as 3D models which may be selected, or of which parts may be selected, in order to provide further information. The geographic relationship between multiple assets is easily visualized. Assets may be stored in relation to time and/or date, and the system is able to retrieve and display asset data in a historical and geographical sense. Scenarios involving changing assets and proposing new assets may be played out by users. Notifications based on the assets may be automatically triggered and sent to users.

This application claims priority from U.S. Provisional Application No. 61/528,748, filed on Aug. 29, 2011, which is hereby incorporated herein by reference in its entirety.

### TECHNICAL FIELD

The disclosed subject matter of the present invention relates to a method and system for combining an organization's asset related data with multi-dimensional spatial information. In particular, it relates to the provision of real-space visualization of anything that can be associated with a geographical location.

### BACKGROUND

A geographic information system (GIS) is designed to store, manage and present all types of geographically referenced data, and may be used to facilitate decision making. At a high level, a GIS is the merging of cartography and database technology. Spatial areas in a GIS may be jurisdictional, purpose or application-oriented. Traditionally, geographical information systems have inhabited a domain specific knowledge area, requiring specialized skills to use and maintain.

There is a need to manage environmental assets spread across a wide geographic area. The costs associated with maintaining these assets are high, often requiring specialist resources to be sent to remote locations. Conversely, the cost of failing to monitor and maintain these assets on a regular basis results in millions of dollars worth of fines and levies in North America each year. In many cases, these fines could have been avoided had the organization had a better way of monitoring where and when these assets needed to be maintained. While spreadsheets are great tools for collecting data, they are less effective at presenting information.

### SUMMARY OF INVENTION

The disclosed subject matter of the present invention provides a geographic asset management system representing a scalable, platform agnostic decision support application that combines an organization's asset related data with multi-dimensional spatial information, providing real-world visualization of anything that can be associated with a geographical location. It is designed to integrate this GIS data with a management and reporting application that supports the tracking and visualization of all assets. These ‘assets’ can be anything from capital assets, such as buildings or computers, to commitments, such as land-use permits or research grants.

The geographic asset management system provides a visual portal to users' information, allowing them to better determine the spatial relationships between the assets that they are monitoring, which is particularly useful when the assets are buildings. This visual representation may, for example, be used to help reduce travel expenses to remote offices, plan locations of medical clinics or stores to optimize coverage in a given area, or compare designs for a new construction project with the existing environment.

For example, take the case where a university faculty that has been experiencing significant growth is now planning a new building. The planning department receives the request for the new faculty building. They have received two similar requests from other faculties in the past month. While the university lands are extensive, a significant portion has been set aside as park land. In addition, the university has many heritage buildings on campus, and a directive to preserve the architectural image of the campus, which limits the size of building projects. The university has also been promoting sustainable communities, and the planning department knows that any new construction must be clearly aligned with this initiative. The planning department identifies potential sites for the new construction and issues requests for proposals. Interested architects are provided access to the university's three-dimensional (3D) model in the geographic asset management system, and are instructed to upload their digital models into the virtual campus. At the next board meeting, the planning department is able to present all of the submitted models in a single session, and review the new building designs next to the existing university structures.

Disclosed herein is a geographic asset management system for presenting assets in a three dimensional rendering, comprising: one or more databases storing asset related data comprising: details of a plurality of assets; geographic locations of the assets; geographic orientations of the assets; and one or more three dimensional models each of one or more of the assets; a server for controlling access to the one or more databases; a user terminal connected to said server for requesting at least some of the asset related data; and a geographic information system; wherein the one or more processors are configured to cause display on the user terminal a three dimensional rendering of a landscape retrieved from the geographical information system and one or more of the three dimensional models retrieved from the one or more databases, each displayed model located and oriented in the rendering of the landscape according to its geographic coordinates and orientation.

Also disclosed herein is a method for presenting assets in a three dimensional model, comprising: storing, by a processor, in one or more databases, asset related data comprising: details of a plurality of assets; geographic locations of the assets; geographic orientations of the assets; and one or more three dimensional models each of one or more of the assets; receiving, by a server, a request to access at least some of the asset related data; transmitting, by the server, said requested asset related data to a user terminal; displaying, on the user terminal, a three dimensional rendering of a landscape retrieved from a geographical information system; and displaying, on the user terminal, one or more of the three dimensional models in the rendering of a landscape, each displayed model located and oriented in the rendering of the landscape according to its geographic coordinates and orientation.

The invention further relates to one or more computer readable media carrying computer readable instructions, which, when executed by one or more processors cause said processors to: store, in one or more databases, asset related data comprising: details of a plurality of assets; geographic locations of the assets; geographic orientations of the assets; and one or more three dimensional models each of one or more of the assets; receive a request to access at least some of the asset related data; transmit said requested asset related data to a user terminal; display, on the user terminal, a three dimensional rendering of a landscape retrieved from a geographical information system; and display, on the user terminal, one or more of the three dimensional models, each displayed model located and oriented in the rendering of the landscape according to its geographic coordinates and orientation.

### BRIEF DESCRIPTION OF DRAWINGS

The drawings illustrate embodiments of the invention but should not be construed as restricting the scope of the invention in any way.

FIG. 1 is an overview of the geographic asset management system.

FIG. 2 is a schematic drawing of the system according to an embodiment of the disclosed subject matter of the present invention.

FIG. 3 is a flowchart showing how the system displays data.

FIG. 4 is a map of the architecture of the system.

FIG. 5 is a schematic diagram of the framework of the system

FIG. 6 is a schematic diagram of hidden details displayed on a local portable device.

FIG. 7 is an example of a display showing a 3D view of a building.

FIG. 8 is a screenshot of a floor of a building showing markings for different types of room.

FIG. 9 is a schematic representation of a screenshot showing a room and an asset located in the room.

FIG. 10 is an alternate representation of the architecture of the system

FIG. 11 is a flowchart of a process for uploading building models to the system.

FIG. 12 is a partial screenshot showing a map, features marked on the map and a legend.

FIG. 13 shows a partial screenshot showing a query result.

FIG. 14 is a menu bar showing the draw option expanded.

FIG. 15 is a partial screenshot showing a feature drawn on a map.

FIG. 16 is a partial screenshot showing a search result.

FIG. 17 is a schematic representation of a screenshot of an assets list.

FIG. 18 is a schematic representation of a screenshot of an asset's details.

FIG. 19 is a schematic representation of a screenshot of a form for adding a proposed asset.

FIG. 20 provides a screenshot showing a form for editing a user's role and organizational unit.

FIG. 21 provides a screenshot showing a form for adding a user.

FIG. 22 is a schematic representation of a screenshot of a list of permissions.

FIG. 23 is a schematic representation of a screenshot of a list of map layers.

FIG. 24 shows a screenshot for editing a role.

FIG. 25 shows a menu bar of the 3D component.

FIGS. 26 and 27 show screenshots with a building model present and absent, respectively.

FIG. 28 is a schematic representation of an environment settings window.

FIG. 29 is a schematic representation of a screenshot of a form for adding a new building model to the system.

FIGS. 30 and 31 respectively show screenshots of a view with underground detail hidden and displayed.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed descriptions that follow are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals, values or parameters capable of being stored, transferred, combined, compared, and otherwise manipulated by one or more processors, each with one or more cores. It will be further appreciated that the line between hardware and software is not always sharp, it being understood by those skilled in the art that software implemented processes may be embodied in hardware, firmware, or software, in the form of coded instructions such as in microcode and/or in stored programming instructions. Furthermore, the processes may be divided into constituent modules or components.

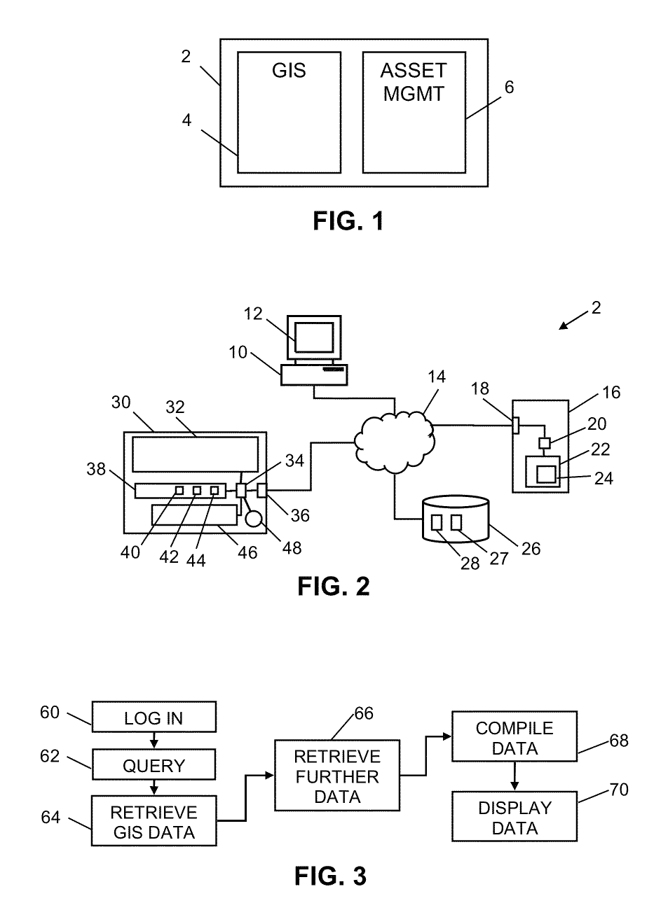

An overview of the geographic asset management system, generally designated 2, is shown in FIG. 1. The geographic asset management system 2 is a combination of a traditional GIS component 4 with an asset management system component 6. The system 2 may be established according to a client-server architecture. For example, referring to FIG. 2, a user of the system 2 may access it through a terminal 10, such as a general purpose computer, desktop computer, portable computer, laptop computer, smartphone, notebook, tablet computer or any suitable computing device that is connectable to a network 14 and has a display 12 or is connectable to a device that has a display. The network 14 may be any data network including, for example only, the Internet, a telecommunications network, a local network, or a combination of one or more of these.

The user may open up a web browser on terminal 10 and browse to the web site of the system 2 which is hosted on server 16 operably connected to the network 14 via interface 18. The connections in the network 14 may be wired or wireless, although normally the connection between the network 14 and the server 16 will be wired, whereas the connection of the terminal 10 to the network 14 may commonly be either wired or wireless. The server 16 houses one or more microprocessors 20, operably connected to a memory 22, which may include non-volatile and/or volatile memories, electronic memories and/or optical memories. Stored in the memory 22 are computer readable instructions 24, which when processed by the processor 20 cause the server 16 to implement functions of the components 4 and 6 of the system 2, as described in detail hereinafter.

Also connected to the network 14 is a database 26, in which is stored GIS data 27 and asset data 28. Asset data 28 may include geographical coordinates of the assets, notes about the assets, times related to the assets, 3D views of the assets, etc. The database 26 alternately may be located in the server 16, or it may be locally connected to it. In other embodiments, the database 26 may be divided into a public information part, such as general geographic information and coordinates and a private information part, such as details of a user's assets. Such private information may be stored on the user's premises or elsewhere, and may be password protected and/or encrypted.

Also shown in FIG. 2 is an example of another terminal, or mobile electronic device 30, which a user may use to interface with the system 2. Basically, the system 2 is accessible by any web-capable device (Windows, Mac, iOS, Android, etc.). Device 30 may, for example, be a laptop computer that is connected to the network 14 via interface 36. The device 30 has a display screen 32 in which a web browser can be displayed for interacting with the server 16 and data in database 26. Device 30 includes one or more processors 34 that connect to and control the components of the device 30, such as user input component 46, which may be a keypad, keyboard or even a touch screen combined with display 32. A memory 38 is included for storing data and programs that can be processed by the processor 34. The memory 38 may store, for example, a browser application 40, an optional local module 42 of the system, a location determining program 44 and any of many possible further components and/or modules that may form part of the system 2.

Data may be displayed on the screens 12, 32 as a two-dimensional (2D) rendering, such as in the form of a map, plan or bird's eye view. Data may also be displayed on the screens 12, 32 as a 3D rendering, such as a perspective view, a view of a landscape, or real-space visualization.

If a browser is not used, which may be the case in some embodiments, the local module 42 may be installed to facilitate the function of specific components on the client. Even if a browser is used, a local module may still be needed for some modules. Localization of the system will allow it to support multiple languages.

The location determining program may determine location itself or with the help of external devices. For example, it may be a hardware GPS device. It may operate based on A-GPS or D-GPS, or it may receive signal strengths from Wi-Fi access points that can be used by a remote server to deduce the location of the device 30. The device 30 may also include an orientation detecting device 48, which may be a compass that may optionally be combined with accelerometers, allowing the processor 34 to determine the pointing direction of the device 30 and/or changes in the pointing direction. The accelerometers may also be used to determine positional changes of the device 30 to a finer resolution than can be provided with GPS.

The computer readable instructions 24 may be prepared using a commonly known programming language or toolset, such as VS2010™, .NET 4.0™, Silverlight™ 4.0, nUnit™, IIS 7.5 Express™, SQL, MEF, EF 4.1, etc.

Referring to FIG. 3, a flowchart is shown of how the system 2 displays data on a device 30. As per step 60 the system 2 accepts a user's login identity and credential, such as a password. An organization would set up users at varying security levels, and then develop a library of assets based on the specific items they were most interested in tracking. A user would only be allowed to access those assets for which he has been authorized. All assets would have a relation to a specific geographic location.

When the user is logged in, the user is presented with a choice of queries that can be made, or the user can define a query. As per step 62 the system 2 receives whatever query the user inputs, and, based on the contents of the query, as per step 64 retrieves GIS information and as per step 66 retrieves further data relating to the assets that are being queried. Data may be retrieved from multiple repositories. The assets can be stored in one or more databases, so long as at least one of the databases is geospatially enabled. As per step 68 the system 2 then compiles the data into an appropriate form, such as a standardized, spatially-enabled form, and then as per step 70 displays the compiled data on the user's screen. A displayed image may include a map with particular assets marked on it.

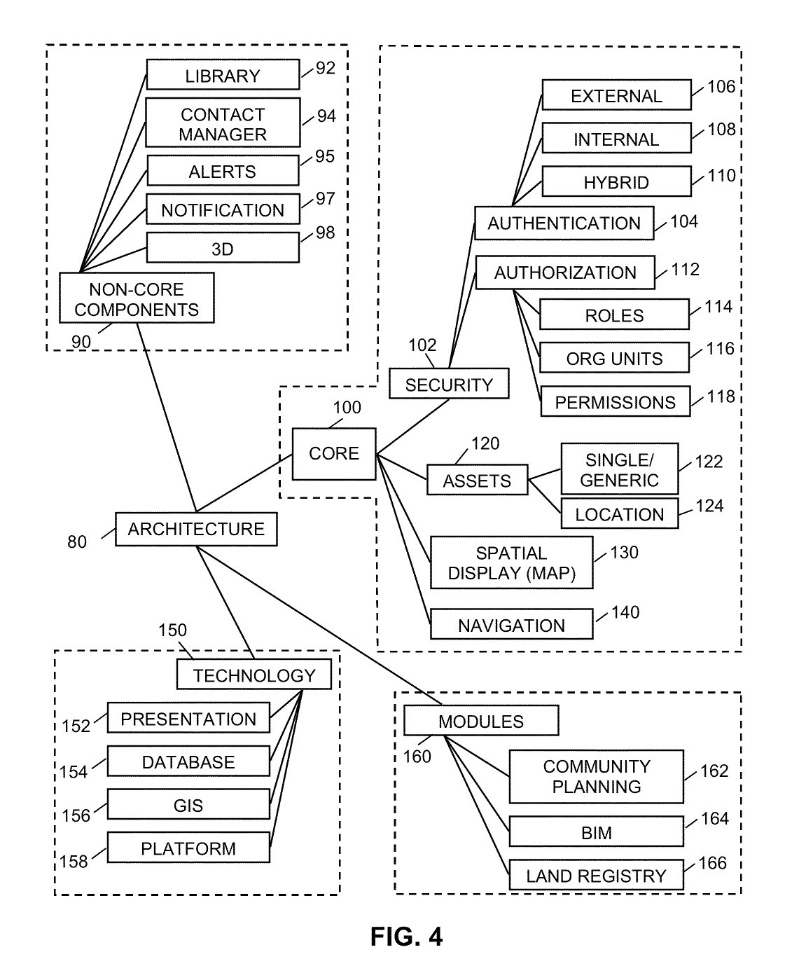

FIG. 4 is a map of an example of the architecture of the computer readable instructions 24 of the system 2. Other architectures may equally be used. The architecture is modularized to provide custom functionality as required by an organization.

In the present embodiment, the overall architecture 80 has four main parts, these being the non-core components 90, the core components 100, the technology 150 and the modules 160. Note that the division between core and non-core components relates to the architecture of the embodiment, and does not necessarily correspond to a boundary of the invention.

The non-core components 90 include a library 92, a contact manager 94, an alerting system 95, a notification system 97 and a 3D visualization component 98. The 3D component 98 may allow for the management of 3D models, such as permitting the upload of a model, upload of a skin, management of names, and management of asset or asset type corresponding to the model. A 3D model may be built into or bundled with a specification of an asset for unity.

The notification component 97 can be configured to notify a user or group of users based on events related to an asset. Events and their associated actions may be stored as alerts 95. Events may range from specific dates to actions in system 2 (e.g., a report submitted against an asset). By displaying these events through a graphical interface (in this case, the map), an organization can quickly determine the geographical relationship between these events to assist in optimizing a response.

The system core 100 is divided into four main parts. The first part is security 102, the purpose of which is to grant access to system functionality and data subsets by configuring roles for users through the system's administrator interface. Security 102 is based on an additive model. No access is the default and access is added based on roles.

Security 102 has an authentication component 104 and an authorization component 112. The authentication component 104 serves to check a user's identification, such as a unique user name and/or unique email address, and credentials, such as a password. Authentication may be achieved externally 106 from the system using LDAP (Lightweight Directory Access Protocol), which is commonly used for accessing and maintaining any organized set of records over an Internet Protocol network. Other systems, such as OpenID and Active Directory may be used. Alternately, the authentication may be achieved internally 108 to the system, or it may be hybrid 110.

The authorization component 112 of security 102 deals with the definition of roles 114 and assignment of roles to users. An organizational unit 116 is a logical group for partitioning assets, and may be referred to as an OrgUnit or User Group. An asset only belongs to one organizational unit directly. Organizational units may be aligned with departments, for example, and may be assigned to users. Through the configuration of relationships between organization units, an asset may be made available to other organizational units. A role is a collection of permissions 118 for access to system functionality and/or data. Roles are assigned to users.

A position is the intersection of a user, organizational unit 116 and role 114 defining the functionality available to a user over an asset. A user can have one or more roles 114 in one or more organizational units 116 via one or more positions. A user may change his personal preferences, such as changing his first and last name, password, email address, etc. However, depending on the embodiment chosen, a user name is not editable by the user.

There is no unauthenticated access allowed by the system 2. A guest account may be set up as a special account, like the administrator's account, and can be enabled to support a “public” style login. The account will be granted permissions similar to any other account but users of the account will not be able to modify any of its settings or preferences.

Security 102 may include both client-side and server-side security, including authentication 104, authorization 112 and role-based permissions 118. Permissions represent the abilities of users to interact with various aspects of the system 2. Such interactions may be the right to create, read, update and delete data. Permissions are assigned to roles.

A system administration component may be included in the computer readable instructions 24 (FIG. 2) to manage various aspects of the system 2. For example, in reference to authorization 112, with respect to users it may be used to add, edit, delete users; manage organizational unit associations; and manage role associations. With respect to User Groups (organizational units 116) it may also be used to add, edit, delete User Groups; manage user associations; and manage role associations. With respect to roles 114 it may be used to add, edit, delete roles; manage user associations; and manage User Group associations.

Assets 120, or details of them, form the second part of the core 100 of the architecture 80. Assets 120 may be single or generic 122 depending on the embodiment, and they are specified with a location 124. The system administration component may also be used to manage asset types. Each asset 120 configured in system 2 inherits security rights, enabling asset data to be restricted by the user's role in system 2. A base asset class may have the following attributes: ID, Name, Description, User Group, Location, MapService and FeatureID. Specific assets may inherit attributes from the base asset class.

Custom assets may be defined, such as buildings or trees. If a building is defined as an asset, it may have the following attributes, for example: project, construction year, material, use, underground parking, designer name, building revision date, green status, heritage, floor height, building width, building length, gross area, and floors. If a tree is defined as an asset, it may have the attributes: type, tag, age, height and morphology. Other items with or without geographical locations may also be defined as assets.

Spatial display (map) 130 is the third part of the core 100 of the architecture 80. The map 130 may have layers that are configurable by admin and secured by role. GIS tools may be included, such as pan, zoom, extent, identify and feature query. Feature query may display a link to the asset details. Drawing tools may also be included such as point, line and polygon, etc. Screen capture may be enabled. Assets 120 may be displayed on the map with icons, by type of asset, and the icons may be colored according to the attribute of the asset. It may also be configured to add a new asset at a point.

The fourth part of the core 100 is navigation 140. The navigation 140 may be driven by a configuration file, which may be managed manually or automatically. The navigation function may include navigation elements that point to core screens, screens within a module assembly or an arbitrary URL. Navigation 140 may send a user to a URL in either a new window or a current window. A navigation element may have the following attributes: name, which is the text to display on the navigation element; URL, which is the destination of navigation action; icon, which is the graphic to display on the navigation element if appropriate; DisplayMode, which is whether to display the text, the icon or both the icon and text; and roles, being the roles required to be able to see the navigation element.

The local optional modules 160 part of the architecture 80 implement specific and desired asset functionality. For example, there may be a community planning module 162, a building information management module 164 and a land registry module 166. Further, optional modules may be added as desired.

The building information management (BIM) system 164 allows space planning in 3D. Where traditional systems have relied on floor plans, system 2 of the present invention depicts in-scale 3D models with selectable rooms. Facility planners using this BIM module are now able to see not only rooms, but also the proximity of those rooms to each other and other building features (elevators; washrooms; wheelchair ramps, etc.).

A file manager may be included in the computer readable instructions 24 (FIG. 2) to manage the various files and records in the system 2. Such a file manager would allow files to be saved to disk; maintenance of meta data attributes; and management of files by asset user interface plugin (asset), by file manager user interface (asset type, organizational unit, unassociated) or by permissions granted to roles.

The technologies 150 that may be used include presentation applications 152, databases 154, a GIS 156 and a platform 158. The system 2 may be platform agnostic, in that it supports multiple database formats (MS™ SQL, Oracle™, Spatial™ SQL, etc). It may also support multiple mapping services (Online [Google™, Bing™, Yahoo™] ESRI™, AutoCAD™ 3D Map, etc).

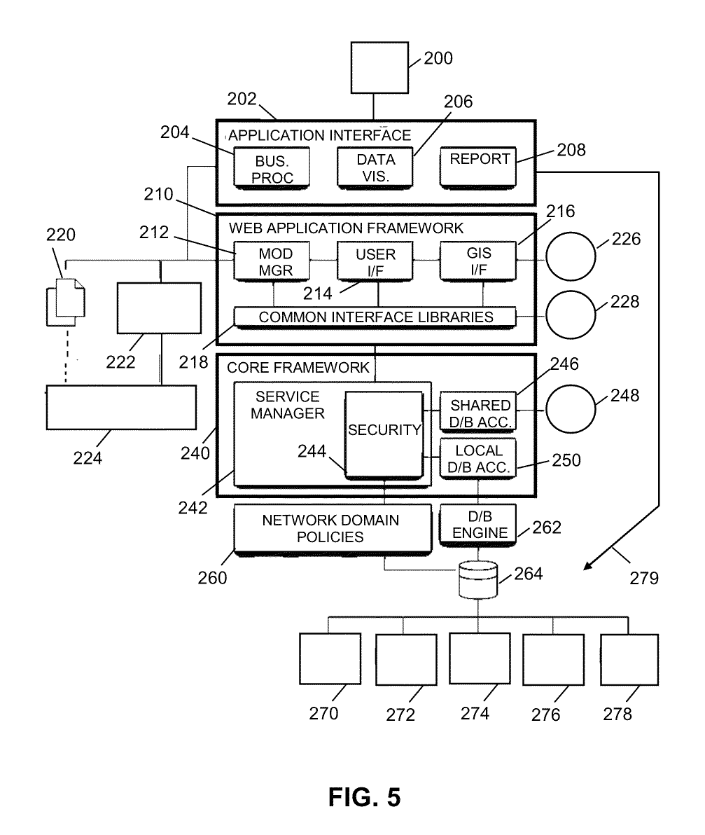

FIG. 5 is a schematic diagram showing an example of a framework of the system 2. The components of the example architecture 80 described above in reference to FIG. 4 may be located together within the framework or separately, depending on the particular embodiment built. A laptop or other network accessible computing device 200 is used to access, from any suitable global location, the application interface 202, which includes interfaces for a business process component 204, a data visualization component 206 and a reporting component 208. These application interfaces may provide the user with access to a document library 220 and a 3D visualization component 222, both of which have access to documents and models stored in a model repository 224.

The user may also access the web application framework 210, which includes a module manager 212, a user interface 214, a GIS interface 216 and common interface libraries 218. The GIS interface 216 interfaces with GIS/map services 226, and the common library interfaces 218 interface with geocoding services 228.

The web application framework 210 provides the link to the core framework 240, which includes a services manager 242, which in turn includes the security controller 244. The security controller 244 manages shared data access 246 and local data access 250. Shared data that is accessed may be provided by subscription data sources 248.

Local data access component 250 may link via a database engine 262 to one or more databases 264, which may be written in MS SQL Server™, Oracle™, MySQL™ or any other database programming and access language. The business logic of data entry forms may be managed by the system 2 using a combination of C# code, for example, and through the use of stored procedures, views and functions within the databases. Databases may be tabular 270, archival 272, spatial (i.e. 2D) 274, temporal 276 or media 278. The security controller 244 may link to the database(s) 264 via a network domain policies component 260, which may allow access using an LDAP, OpenID™, WebADE™, Active Directory, etc or a custom protocol.

Client side output, such as pictures, video, 3D models, reports etc., as displayed on the data visualization component 206 or created in the reporting component 208, may be fed via link 279 back to the database engine 264 and/or databases 270-278. Likewise, analytics of clients' usage and loyalty may be fed from the users to the database engine 264 and/or databases 270-278. The system 2 may track all transactions that are executed against the database history and metadata tables. These tables can be used to perform audits, repair damaged records and produce reports.

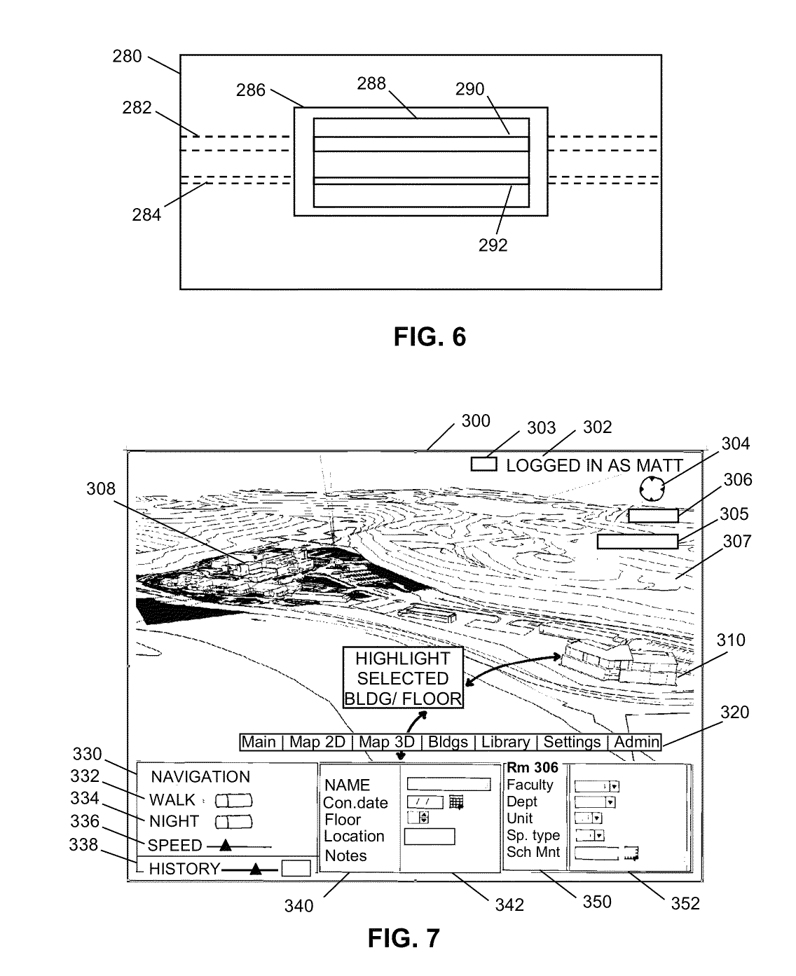

As mentioned above, different architectures may be used. An example of an add-on module is shown in FIG. 6. Such an add-on module to the core system will allow users to track assets at a more granular level than traditional GIS systems. For example, Insight NR™ (New Reality) as provided by CloverPoint™ will provide users with the ability to locate and interact with assets that are normally hidden from the naked eye. Using location based services, a user will be able to access information about an asset based on the location and orientation of their Internet-capable mobile device. The end effect will be the virtual ability to look through walls. In FIG. 6, a wall 280 is shown behind which there are two pipes 282, 284, which are not normally visible. A smartphone 286 is placed in proximity to the wall, and its internal orientation detecting devices and location based services allow the server to determine what a user would see if looking though the wall at the position of the smartphone and in the direction the back of the smartphone is facing. In this case, views 290, 292 of the two pipes are shown on the display screen 288 of the smartphone. This module may also be used for visualizing underground pipes, cables and fibers, etc.

FIG. 7 shows an example screen shot 300 of a landscape provided by GIS system component 4 (FIG. 1) enhanced according to the system 2 with 3D component 98 (FIG. 4). A user is shown to be logged in 302 as Matt, according to the security setting of the system 2. A log out button 303 may be present adjacent to the display of the logged in status. At the top right of the screen is a compass 304 indicating the direction of the view. The geographic (x, y) coordinates 306 of the view (or the center point of the view) are also displayed. Alternately, the coordinates given may be that of a cursor that can be tracked over the view. The z coordinate may also be displayed. A search box 305 may be included in the display, for searching for buildings, rooms, space type, or any other item or feature related to the landscape. The view shows contours of a hillside 307 and a group of buildings 308. A 3D model of a building 310 is also shown. This building may be defined as an asset of the system. The building may be selected, or floors or rooms of the building may be selected, and then navigated to.

A menu bar 320 allows a user to easily move around the site. For example, the user may switch from a 3D view to a 2D view. The user may toggle the buildings model layer on and off. The user may go to the main page, the settings page or the admin page. The user may go to a library listing all the assets. The menu may be positioned anywhere on the screen, and could be along the top of the screen, for example.

Navigation display block 330 allows the user to toggle the walk mode 332 on and off, and to toggle the night mode 334 on and off. The speed at which the view is explored may be set by a slider 336. Below the navigation block there may be a history slider 338, which can change the view according to date, which may also be displayed alongside the slider. Alternately, dates may be entered explicitly, selected or stepped through, etc. As an organization collects data on assets over time, it can make use of the timescale functionality to track historical trends in order to better configure the notification system (i.e., an equipment failure at plant A will raise the load at plant B to critical levels within 2 days, unless plant C is brought online). Where most traditional GIS systems are reactive in nature, the present system provides users with a decision support system to optimize their future plans.

The tombstone block 340 displays headings for the asset selected, the values of which are shown in data block 342. Shown, for example, in block 342, is the name of the building that is selected, the construction date, and a specific floor if one is selected. A floor may be selected either by clicking on the corresponding floor of the 3D building model 310 or by selecting from the up/down selection arrows. The location of the building may be displayed by showing its geographic coordinates. Any notes that have been added to the system 2 may also be displayed. Depending on the permission granted to the user, the user may be able to add or edit notes relating to the building. In a similar way, a selected portion of the asset may be shown in asset heading block 350 and data block 352. For example, if a room of the building is selected, the room name or number may be shown, the faculty to which it belongs, the department, the unit, the space type (e.g. lab, office, meeting room, canteen, etc.) and the next scheduled maintenance date. Users may add and remove assets as a way to facilitate the consideration of alternate scenarios.

Such a client enterprise asset visualization component 98 or 2D view may allow users to drill down functionality to a site, building, or asset's information. It may permit spatial calculations on the fly to instantly report on key aspects, such as, for example, the number of assets in a 5 km radius due for maintenance in the next 15 days, or linear feet of pipe that needs to be replaced.

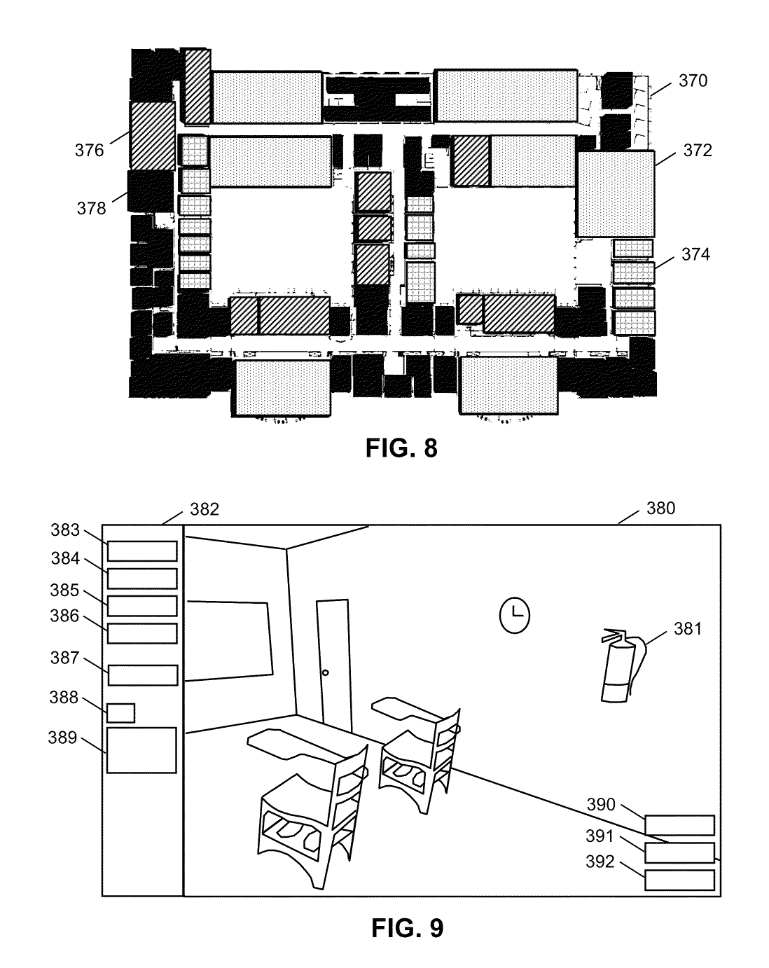

FIG. 8 shows an example of a partial screen shot displaying a plan of a floor 370 in a building. In this view, different rooms have been marked according to different classifications 372, 374, 376, 378. This may be useful, for example, when a hospital is expanding. New buildings may be being built to accommodate certain groups. While the construction is going on, rooms may need to be reallocated. The facilities manager may have received lists of requirements from each of the wards affected by the move. She would then use these parameters to display all of the rooms that meet these criteria, as well as their proximity to supporting infrastructure. Using the system 2, the facilities manager would be able to prepare a number of simulations of space usage. These simulations, combined with hospital usage metrics, would allow the facilities manager to prepare and present an optimum solution that minimizes the impact to both patients, visitors and staff. Navigation buttons may be included to allow the user to switch from floor to floor in each building stored in the system 2.

FIG. 9 is a schematic representation of a screenshot showing a room 380 in a building, and an asset 381 located in the room. In this example, the asset is a fire extinguisher, although other types of assets may be included. To the left of the screenshot is a side bar 382, which may contain asset number 383, asset name 384, purpose 385 of the asset, which in this case would be safety, and date and time last inspected 386. There may be a button 387 for entering or viewing details of an inspection. There may also be an edit button 388 for editing notes 389 that may be included in the side bar 382. At the lower right portion of the screen are a further set of buttons, for accessing the controls 390, the management system 391 and to logout 392. The controls 390 are for configuration settings for the application. These allow the user to pull new information from the server, search for items, or load a pre-saved configuration (i.e., meeting room tables instead of desks). The controls 390 may be condensed into the toolbar.

Using this aspect of the system 2, support staff and contractors can be directed to the exact location of assets requiring maintenance. For example, an electric company may have dispatched an employee to a university to install a high voltage socket. As part of the ticket issued by the university's facilities manager through the system 2, the contractor would have been provided with a map with a 3D view showing the location of the new socket, which would also display the nearby infrastructure. The facilities manager may also have left specific notes regarding how to interact with the infrastructure at several positions on the map. All of this information may be made available to the electric company employee through a mobile computing device. While the contractor is on site, the facilities manager may receive an alert through the system 2 that there is an electrical problem in a neighboring building. Seeing that the electrical contractor is still checked in at the campus, the facilities manager may place a call to arrange for the contractor to look at the new issue before leaving. Improved information sharing using the system 2 therefore leads to less time spent resolving issues, and lower facility maintenance costs as a result.

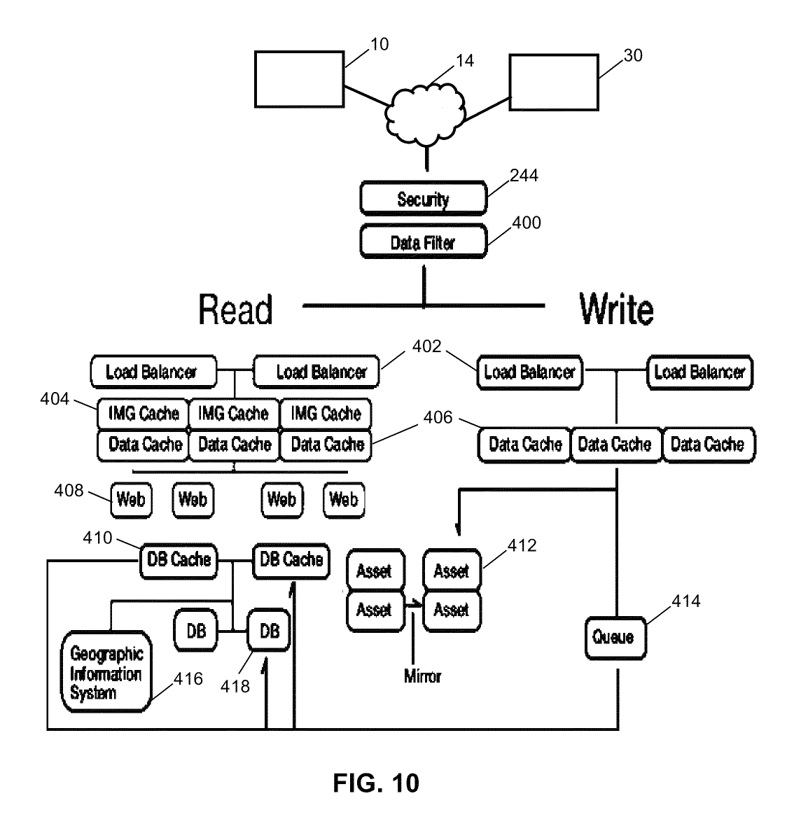

FIG. 10 is an alternate representation of an example of the system 2. Devices 10, allow users in the cloud to connect to the system 2 via the Internet 14. Such a device 10, 30 may also be used for viewing hidden detail, as described with respect to FIG. 6. Connection is via a security component 244 and a data filter component 400. The data filter allows users to read and write to the databases depending on their authorization levels, or roles.

Reading functions may use one or more load balancers 402, one or more image caches 404 and one or more data caches 406 to retrieve data 412 from various web sites 408, and databases 418 and the GIS 416 via a database cache 410. Writing functions may use one or more load balancers 402 and one or more data caches 406, and data to be written may be queued 414 before being written to a database 418. Asset information 412 may be backed up either by mirroring the database(s) or by striping them.

Building Model Upload

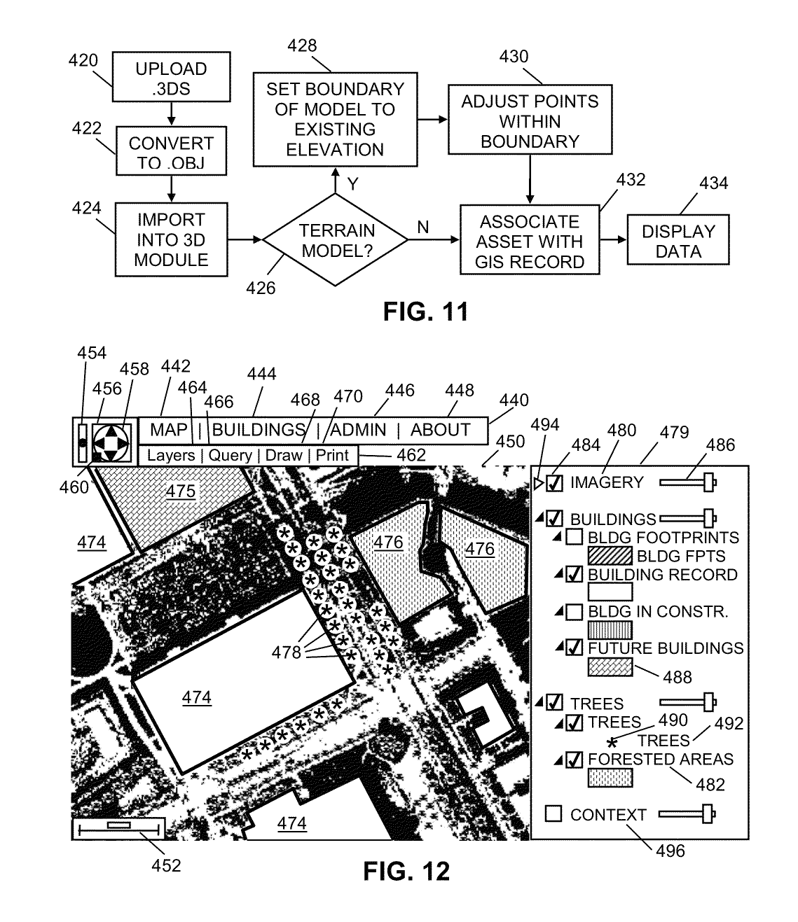

FIG. 11 is a flowchart of a process for uploading building models to the system 2. An embodiment of system 2 supports the uploading, in step 420, of building models from any 3D modeling software that can save to the 0.3DS file format. For example, Studio MAX™, Maya™, and Sketch-Up™ all support this format. The final model should be saved as a single mesh/object, with all interior detail removed, normals of the building surfaces facing outwards, and all points and polygons not associated with the model geometry removed. Depending on the embodiment, the polygon count may be limited to a maximum, for example only, of 60,000. Likewise, the scale may be constrained to have a given conversion, which may be 1 m to 100 units, again as an example only. These files are detected and converted during the upload process, in step 422, into the .OBJ format, which can then be imported, in step 424, into the 3D component 98 (FIG. 4).

Reflecting the realities of large-scale construction, the existing terrain may need to be adjusted to accommodate the new building model. An uploaded building model can therefore be associated with an optional terrain model. This terrain model alters the appearance of the landscape in the existing 3D scene, either increasing or decreasing the elevation based on the parameters of the terrain model that is uploaded.

In step 426 it is determined whether a terrain model is uploaded in conjunction with the building model. The terrain model should be a separate 3DS file, with similar guidelines applying to it as to the building model file. If so, the software compares the elevations of all points within the boundaries indicated by the uploaded terrain model with the existing terrain. The boundaries of the model are set to match the existing elevation in step 428, and then all points within the boundaries are adjusted based on their relative coordinates using a ray-cast algorithm, in step 430. This creates an adjusted terrain, according to the terrain model, that blends seamlessly with the existing landscape and can be used for one or multiple building models. Below is an example of an algorithm that is used in the process of FIG. 11.

```
  private var maxX : float=−10000;
  private var maxZ : float=−10000;
  private var minX : float=10000;
  private var minZ : float=10000;
  private var shootHeight : float=500;
  private var hitDown : RaycastHit;
  private var layM = 1 << 15;
    var vertices = terrainObject.GetComponent(MeshFilter).mesh.vertices;
    //Sets the bounding Square of points to be used in the heightmap
  for(var i = 0; i<vertices.length; i++){
    var point = terrainObject.transform.TransformPoint(vertices[i]);
    if(point.x > maxX){
      maxX = point.x;
    }
    if(point.z > maxZ){
      maxZ = point.z;
    }
    if(point.x < minX){
      minX = point.x;
    }
    if(point.z < minZ){
      minZ = point.z;
    }
  }
    //****This algorithm loops through the terrain pieces of the parent terrain container
and alters each pieces vertice array.
  //****It uses the pre-determined point bounds to alter only points within the affected
area.
  //****Any point within this area is used as a reference point for shooting a line
raycast onto the imported terrain from the existing terrains reference points.
  //****The hitpoint is then applied to the reference points transform essentially
mapping onto the imported terrain.
  //****The newly created vertice array is then applied to the existing terrain.
  for (var child in terrain.transform) {
    var terrVerts : Vector3[ ] = new
Vector3[child.GetComponent(MeshFilter).mesh.vertices.length];
    terrVerts = child.GetComponent(MeshFilter).mesh.vertices;
    for(var q = 0; q<terrVerts.length; q++){
      var terrPoint = child.transform.TransformPoint(terrVerts[q]);
      if(terrPoint.x < maxX && terrPoint.x > minX && terrPoint.z <
maxZ && terrPoint.z > minZ){
        if (Physics.Raycast
((terrPoint+Vector3(0,shootHeight,0)), Vector3.down, hitDown, Mathf.Infinity, layM))
{
          terrVerts[q].y =
child.transform.InverseTransformPoint(hitDown.point).y−0.02;
        }
      }
    }
  //This applies the new mesh vertice array and Recalclate its Bounds
    child.GetComponent(MeshFilter).mesh.vertices = terrVerts;
    child.GetComponent(MeshFilter).mesh.RecalculateBounds( );
```

The placement of asset models occurs by two methods: placement of existing structures; and placement of proposed structures with optional terrain changes. Before an asset model can appear in the 3D component 98 it must be associated, in step 432, with a record in the asset management system 120. Where this record is conjoined with GIS data, the position of the model will be determined by the position (or footprint) recorded in the GIS. This is most often the case for an existing structure. These models will appear by default in the 3D component 98, when the data is displayed, in step 434.

Where a record does not have a corresponding GIS record, the user can enter the coordinates at which the model should appear in the 3D component 98. The model will be placed at these coordinates according to its centroid, or pivot point, as determined by the 3D modeling software that was used to create it. The model ought to have a known origin or axes point that is positioned at its center. A rotation with respect to north should also be included. These models, most often referencing proposed structures, can be injected into the 3D component based on the role of the user and the permissions associated with the model. These proposed models may or may not be accompanied by a terrain model.

Assets may be updated via a mobile process. Based on the asset hierarchy established by the organization's data structure, assets or children of assets with corresponding system records can have these records updated through a web-enabled mobile device. A user of the system can use the mobile device to navigate to a visual representation of the object. This can be determined by the real-world location of the device or manually selected by the user. The user can select the object as it appears in the mobile 3D component 98, access information about the asset stored in the database 28, and even edit or update this information without directly accessing the management system.

Textures for the building models can be uploaded, too. A texture map can be uploaded as a JPG or PNG format file, for example, and may even by a photograph or photographs. If a texture map is not uploaded, a default texture will be applied, such as a concrete texture. Depending on the embodiment, there may be constraints required for texture files, such as a maximum pixel count (e.g. 2048×2048) and the pixel lengths and widths being divisible by 2.

Further Screenshots of an Exemplary Embodiment

FIG. 12 shows one of the main sections of the system 2. At the top is a menu bar 440 that shows how a user may access the various parts of the system 2. There are four main menu items: Map 442; Buildings 444; Admin 446; and About 448. According to the level of permissions set, only the items available to the user will be displayed in the menu bar. The map section 442 of the system allows users to see maps with various layers added to identify the assets recorded in the system 2. The map screen may be the default display mode of the system 2. The buildings section 444 allows users to see lists and details of the buildings recorded in the system's database. The admin section 446 allows an administrative user, or users with administrative permissions, to add and edit users and to assign users to roles and organizational units. The about section 448 provides access to the usual type information that would be found in such a section.

The screenshot of FIG. 12 shows a map 450 displayed by the system 2. The map includes a scale 452, a zoom bar 454 and navigation buttons 456. The zoom bar 454 may be used to enlarge or shrink the detail of the map. Alternately, a user may double click on a point in the map to zoom in at that point. The navigation buttons 456 can be used to move around the map by clicking and holding one of the arrows. The navigation ring 458 may be clicked and dragged either clockwise or counterclockwise to rotate the view of the map. The home button 460 may be clicked to return the display of the map to its default position.

A tool bar 462 may be shown, including items labeled Layers 464, Query 466, Draw 468 and Print 470. The view shown of the map 450 is for when the layers item 464 is selected. For example, the buildings layer is selected and displayed, causing the map to show buildings 474 for which there is a record in the system and future buildings 475. Forested areas 476 are also shown, as well as trees 478. To the right of the map a side bar 479 is displayed which includes a legend for the various main layers, such as imagery 480, of the map 450. Sub-layers may also be included, such as forested areas 482. The side bar 479 includes check boxes 484 which allow the user to toggle the display of the relevant layer on and off. Slider bars 486 are also included, which can be used by the user to set the display opacity of the respective layer. The legend includes patterns or color boxes 488 for each of the layers, or symbols 490. A name 492 for each pattern or symbol titles may be displayed. Advanced layer attributes may be accessed by clicking the arrow 494 to the left of the check boxes. Layers are assigned to a role before they can be accessed by users. One of the main layers may, for example, be ‘Context’ 496. In this example it is a layer that is read from the GIS. The title, in this case ‘Context’, is set by the individual who created the layer. The user who created it intended it to reflect scale. However, it could potentially be anything that a user may want to appear on a map.

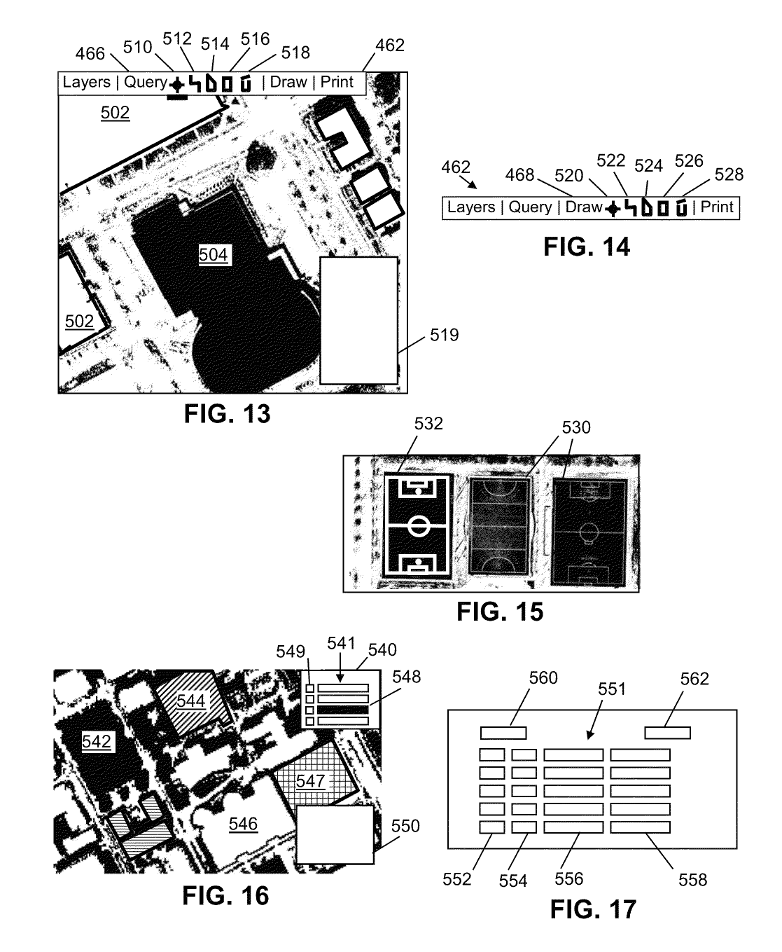

FIG. 13 shows a partial screenshot showing a query result. The query item 466 of the tool bar 462 has been selected and expanded to show various tools for making a query. In this case, the tool options are: selecting by pointing 510 to select a single object; selecting by drawing a line 512; selecting by enclosing map objects within a polygon 514; selecting objects within a rectangle 516; and discarding currently selected objects 518. In the example shown, various buildings 502, 504 are marked, and building 504 has been selected using the pointing tool 510. Details pertaining to the selected map item or items may be shown in one or more query results boxes 519.

FIG. 14 is a menu bar showing the draw option 468 of the tool bar 462 expanded. In this case, the tool options for drawing are: placing a point at the position of the cursor 520; drawing a line 522; drawing a polygon 524; drawing a rectangle 526; and resetting the map 528. The draw tool allows shapes to be temporarily drawn on the map. FIG. 15 is a partial screenshot showing a feature drawn on a map, when the draw item 468 from the tool bar 462 is selected. The map shows existing sports fields 530, with a further sports field 532 drawn over the map. The circle in the center was drawn as a polygon, although a circle draw tool may also be included.

The print option 470 from the tool bar 462 may be selected to print the screen as it is displayed on the computer in use, complete with any markups that may have been drawn on it.

FIG. 16 is a partial screenshot of a map showing a search result. The search option allows a user to search the asset database and have the results displayed in a search results window 540. The search results window contains a list 541 of results, shown on the map as buildings 542, 544, 546, 547. Each of the results may be selected to cause it to be highlighted on the map. In this case, the result 548 has been selected highlighted as building 542 on the map. Each result in the list 541 may, when selected, or when an associated details button 549 is selected, cause the display of a details window 550, containing information in the record about the selected building asset 542.

FIG. 17 is a schematic representation of a screenshot of a buildings, or assets, list 551. All assets currently accessible are displayed, but the display of assets may be restricted by permissions. The first column has details buttons 552 for accessing the information about each asset. The second column contains asset numbers 554. The third column contains asset name and optionally its address 556. The fourth column contains asset status information 558, such as the date it was built and whether it is existing, under construction or proposed. A search button 560 allows users to search for buildings, and an add button 562 allows users to add proposed buildings. The search button 560 allows a user to type in a name, asset number, partial address, etc. to filter the items appearing on the buildings list screen.

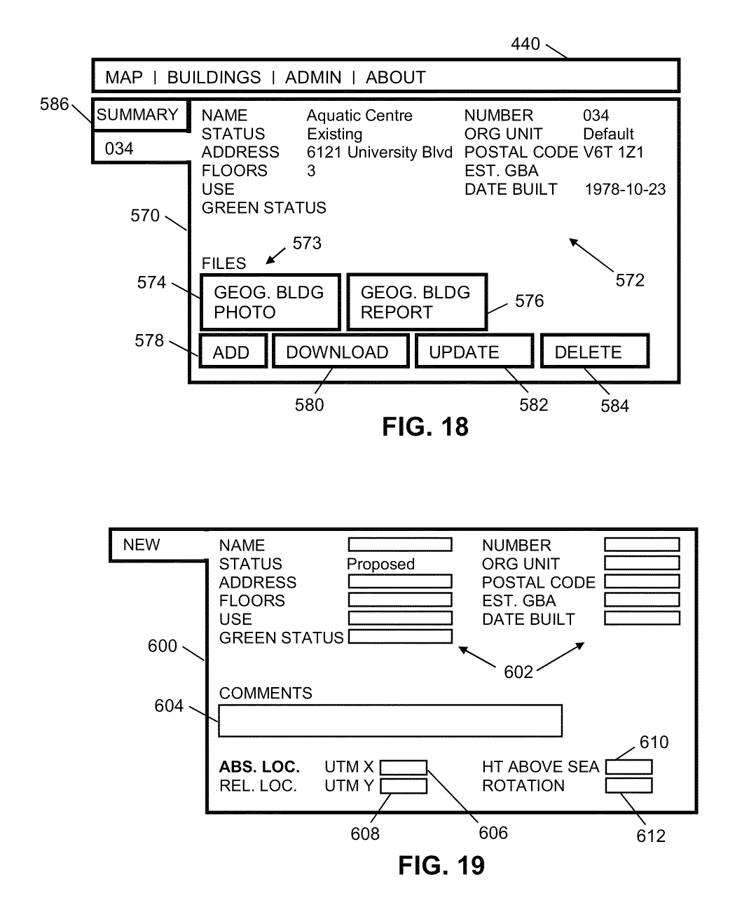

FIG. 18 is a schematic representation of a screenshot of a building's detailed information page 570. Such an information screen may be accessed from the buildings list 551 (FIG. 17) by clicking on a details button 552. Different fields 572 are visible and/or editable depending on the permissions of the user's role and the status of the building. The fields may include, for example, name, status, address, number of floors, use, green status, number, organizational unit, date built, estimated gross building area (GBA), etc. Gross building area is the sum of areas of all floors in a building, and provides another example of how users can use the system to create user-friendly names. In the information page 570 shown, a files section 573 is shown with icons or buttons 574, 576 that link to files that have been uploaded and associated with the building. The files section 573 may be collapsed and expanded. There is an add button 578 for adding a further file, a download button 580 for downloading files or information pertaining to the building, an update button 582 and a delete button 584. By clicking on the summary tab 586, the user is taken back to the list 551 of buildings shown in FIG. 17.

FIG. 19 is a schematic representation of a screenshot of a form 600 for adding a proposed (or conceptual) asset, which can be arrived at by clicking add button 562 in FIG. 17. This detailed form allow a user to enter information in fields 602 about the proposed building. An area 604 for comments is also included. In order for the new building to be accessible in the 3D component, information about its position (Universal Transverse Mercator coordinates UTM X 606 and UTM Y 608, height above sea level 610) and angle of rotation 612 with respect to a reference should be provided, as well as a model and texture. Only buildings with the status ‘Proposed’ can be added to the system.

When a proposed building has been approved for construction it is first added to the default building database and has a unique ID assigned to it. Once this has been done, the detailed building record 570 can be opened and the status of the building can be updated. This may be done using a drop down button, for example. The unique ID creates an association between the building record and its corresponding 3D model.

Once a building status is changed from ‘Proposed’ to a different status, most of the data fields will be automatically populated with the information recorded in the default building database. In order for the building to appear on the map screen, the building footprint should also be added to the appropriate layer in the GIS system 4. In this embodiment, once the status of a building has been changed from ‘Proposed’, it cannot be reversed. The order in which the status of a building changes is: Proposed; Approved; Under Construction; and Existing.

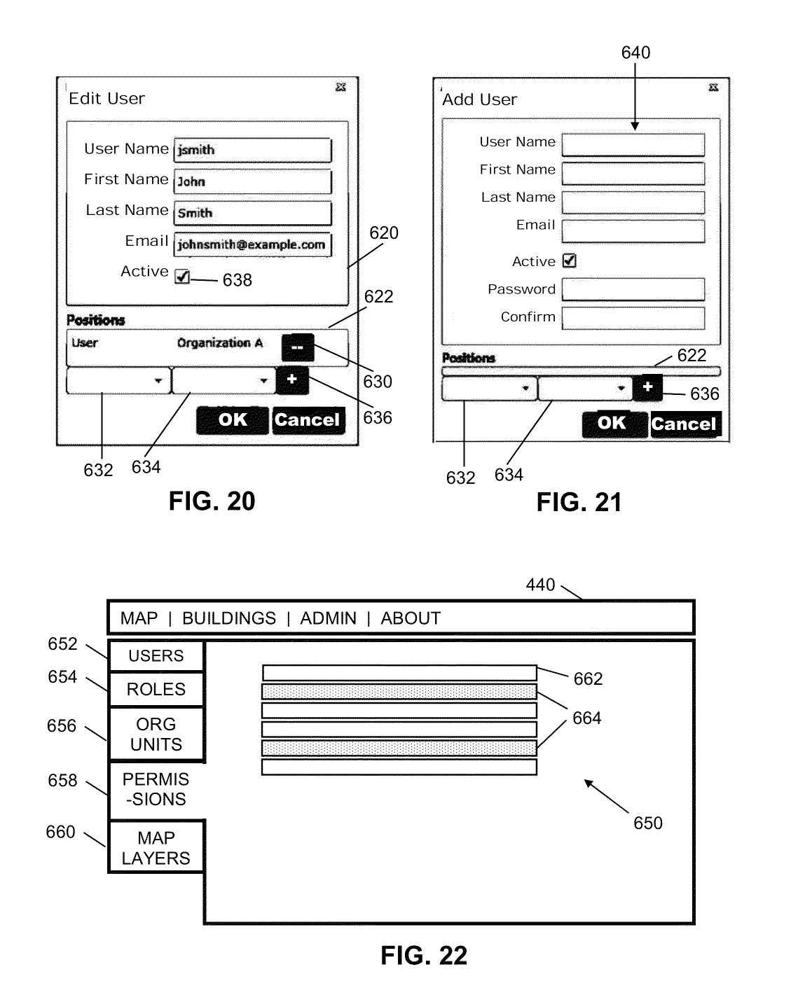

FIG. 20 is a screenshot showing a form for editing a user's role and organizational unit within the authorization component 112 (FIG. 4) of the system 2. The authorization component provides various administrative screens. The edit user form has an area 620 for the user's personal details, such as name and email, and an area 622 for the user's position, the position being defined as a role and an organizational unit. In this example, the role is “User” and the organizational unit is “Organization A”. The role and organization unit may be deleted with the delete button 630 and new ones selected from the pull down lists 632, 634, and added to the user's position with the add button 636. The user's personal details can also be updated as and when required, by entering the new information in area 620 of the form. The status of the user can be changed from active to inactive using the check box 638. An inactive user will retain all of his assignments, but is not able to log into the system 2.

FIG. 21 is a screenshot showing a form for adding a user. Personal details can be added in the vacant fields 640. The role can be assigned using the drop down list 632 and the organizational unit can be selected using the drop down list 634, both of which can be added to the user's positions 622 with the add button 636.

FIG. 22 is a schematic representation of a screenshot of a list of permissions 650, accessible within the authorization component 112 (FIG. 4). The administrative screen includes the five sections: users 652; roles 654; organization units 656; permissions 658; and map layers 660. Here, the permissions tab 658 has been selected. From the list 650 of permissions, some are not selected 662 and some are selected 664, according to the role. Permissions may, for example, be selected from the following: allow users to create new assets; allow users to edit assets; allow users to delete assets; allow users to manage map layers; allow users to manage other users; allow users to manage their own password. Permissions are assigned to a role, which is then assigned to one or more users. Changing the permissions allocated to a role will affect all users that have that role assigned to them. Roles can be edited, added and deleted much in the same way that users can.

The users tab 652 provides access to a list of users recorded in the system 2. A search function may be included to allow one to search for a user or users. Users may be deleted from the system directly from the user list.

Organization units, accessible via tab 656, are security groups that can be used to restrict access to assets in the system 2. For example, by default, proposed buildings are only accessible to system administrators and members of the organization unit under which they have been created. Every user in the application is assigned at least an organization unit and a role. Users can belong to more than one organizational unit, and can have different roles in each. As with users and roles, organizational units can be edited, created and deleted. It is preferable for each group responsible for submitting proposed building models to be set up as distinct organizational units

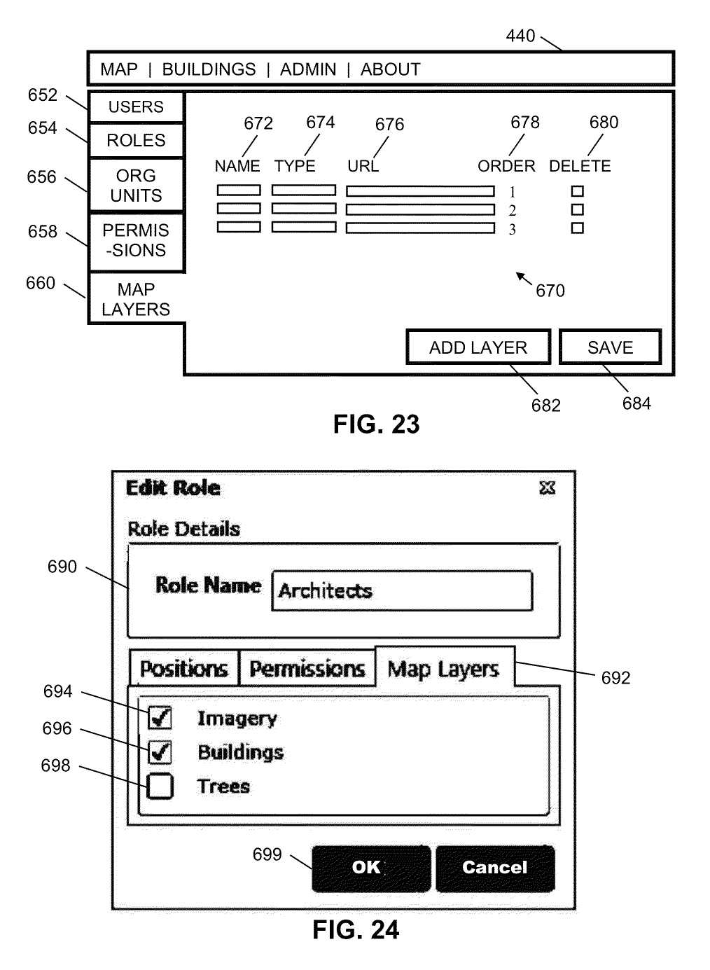

The map layers tab 660 provides access to a screen shown in FIG. 23 that allows users to add new layers from the associated GIS system 4 for display on the map screen. Layers are shown as a list 670, each layer defined by a name 672, a type 674, a URL 676 and an order 678 in which it is displayed in the layer window of the map. Each layer has a check box 680 allowing a user to delete it. To add a layer it is first created as a web service in the GIS system 4. By clicking the add layer button 682, entry fields are displayed for the entry of details defining the new layer. New layers added by clicking the save button 684. Likewise, layers selected for deletion can be permanently deleted.

Once a layer has been created it should be assigned to one or more roles in order to be visible. The roles tab 654 can be opened to show a list of roles. The role desired to be given access to the new map layer is selected for editing, resulting in the display of the edit role window of FIG. 24. The name of the role is displayed in box 690. The map layer tab 692 is selected, showing checked boxes 694, 696 for layers that are accessible by the role and an unchecked box 698 for a layer that is not accessible to the role. By clicking on the check boxes 694, 696, 698, the accessible layers can be changed and then saved by clicking the OK button 699.

An MXD (Map Exchange Document) is a way of grouping layers, which is itself treated as a layer. We can then assign permissions to the individual layers, or to the MXD ‘master layer’. It may be necessary to create an MXD file for a group, such as utilities. When creating the MXD file, it can be created in any projection but every MXD file should have the same projection. Multiple scale levels will need to be set if the map will be cached (tiles created), otherwise the dynamic tile service may be used. The display field for each layer should be useful and unique, and can be done in the MXD file. The unique display field will be the primary display field in the system 2. The attribute table should be reviewed to only show desired attributes, to change names to meaningful names, to check whether ID fields are correctly populated, to add a description field if required, and to check that there is a ‘last updated’ timestamp.

A dynamic or tiled service can be added to the system 2 using the server manager in the administration section. The dynamic service is a real time service driven straight from the map that can be updated quickly and easily. Tiled service is a static service of map images for various pre-set scales. A tiled service is faster in performance, but takes longer to generate if updates are required. The maximum number of instances of the service should be set to one more than the number of cores in the processor on the machine the system 2 is running on.

Further Screenshots of an Exemplary 3D Component

The 3D component 98 may be downloaded and installed separately from the core components of the system 2. Depending on the performance specification of the computer on which the 3D component is to be run, different levels of graphics quality are offered. For example, selecting a ‘Good’ graphics quality will allow the 3D component to run smoothly on an 800×600 resolution screen if the computer has at least: Windows 7™ operating system; Intel Core 2™ or AMD Athlon™ dual core processors; 4 GB of RAM; Nvidia Geforce 9500GT™ graphics card; 512 MB graphics card memory; and 3 GB of free hard disk space. The keys used to navigate around the 3D view in the 3D component 98 may be customizable. For example, the keys could be: W—forward; S—backward; A—left; D—right; Shift—hold to increase movement speed; Tab—toggle mouse selection; and G—toggle gravity.

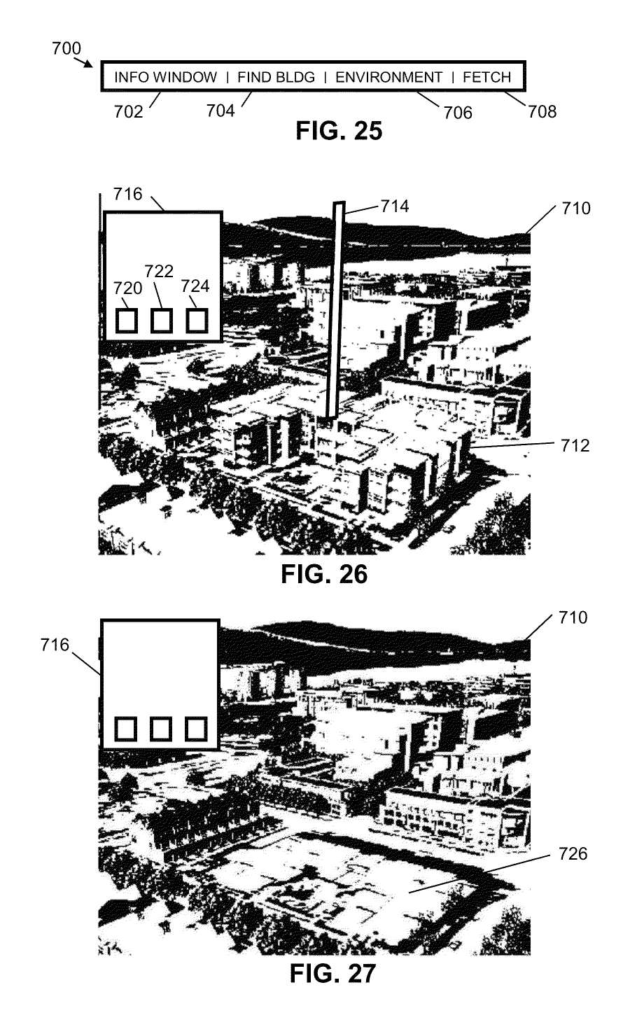

FIG. 25 shows a menu bar 700 with the main four components of the 3D component 98 (FIG. 4). The menu items are: Information Window 702; Find Building 704; Environment 706; and Fetch 708.

FIGS. 26 and 27 show screenshots with a building model present and absent, respectively, as viewed using the 3D component 98. FIG. 26 shows a scene 710 with a 3D model of a building 712 that has been clicked on by a user. As a result of clicking on the building model 712, a marker 714 is displayed that indicates the building model.

The information window 716 is also displayed, which contains metadata and positional information about the selected building 712 or other object. Information may include building name, address, purpose, type of construction, year and date built, height, etc. At the bottom of the information window 716 there are three buttons. The first button 720 is used to hide and show the currently selected object. The second button 722 is used to show and hide all objects of the same type. The third button 724 is used to zoom to the selected building and rotate the point of view around it. Clicking the button 724 again will stop the rotation.

FIG. 27 shows the same scene 710 as in FIG. 26, without the building model 712, as a result of a user clicking the button 720 or 722. Instead of the building 712, the footprint 726 of the building is shown.

When the user selects the find building item 704 (FIG. 25) from the menu bar 700, a building search tool is provided to the user. Users can search for a building by name or number by typing all or part of their query into the search box and clicking ‘Go’ (for example) to get a list of possible matches. By clicking on a record in the list, the 3D view zooms to the corresponding building.

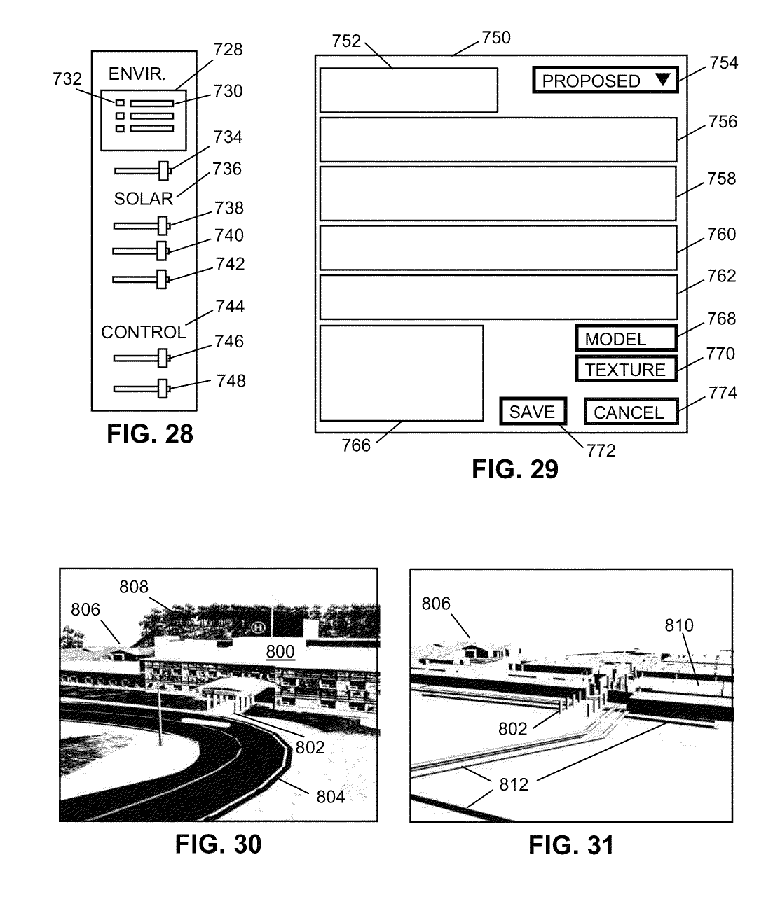

The environment item 706 of the menu bar 700 allows users to toggle layers, adjust settings and conduct shadow studies. When selected, an environment settings window as shown in FIG. 28 is displayed on the screen, either beside the 3D view or overlaid on it. It may be partially transparent if overlaid. The environment setting window includes settings 728 for layers, such as layer 730, that that can toggled on and off with buttons 732. Layers may include trees, ortho/painted (Ortho refers to an orthophotograph, which is a geometrically corrected aerial photo that provides the image of the map. A painted ortho is a geometrically corrected aerial photo that has been artistically enhanced with a graphics editing tool—‘painted on’.), buildings, clouds, roads, road names, shadows, etc. A field of view slider 734 may be included to allow a user to adjust the angle of the field of view. A section 736 for setting the solar position may be included, which may include a slider 738 for setting the time of day, a slider 740 for setting the day of the month, and a slider 742 for setting the month of the year. A section 744 for setting user controls may be included, with a slider 746 for adjusting the mouse sensitivity and a slider 748 for adjusting the “flying speed” of the user as his point of view of the 3D scene is changed.

The fetch item 708 of the menu bar 700 will cause a window to be displayed via which all available buildings and associated terrains from the system 2 can be imported into the 3D component 98. The buildings available to a user are those that the user has uploaded and those that have been uploaded by other members of his organizational unit. One or more of the available buildings can be selected and downloaded to the 3D component 98, and placed in it in the desired location. A single terrain model can be used for multiple building models.

To upload a new building model to system 2, the desired coordinates need to be known. They can be determined by going to the desired location for the building in the 3D component, selecting an existing building to be replaced, or by clicking on the ground where the new building model is to be located. The 3D component will then provide the UTM X and Y coordinates and the height above sea level, which can be transferred to a new building record in the main system 2.

FIG. 29 is a schematic representation of a screenshot of a form 750 for creating a new building record and adding it to the system 2, arrived at by clicking the add button 562 of FIG. 17. The form 750 includes: an area 752 for the building name; a drop down selection list 754 for setting the status of the building; an area 756 for the address and details such as the number of floors and whether there is underground parking; an area 758 for further building details such as number, designer name, year built, whether heritage or not, building visitors, drawing revision date, green status, etc; an area 760 for building dimensions; an area 762 for comments; and an area 766 for geographic coordinates and rotation expressed as an angle from north. There may also be a drop down list for setting the organizational unit. Once the details of the building have been entered, a model for the building can be selected by clicking the model button 768, which will lead the user to a list of available models that can be selected. Similarly, a texture for the building model can be selected by clicking on the texture button 770. The choices made can then be saved and uploaded by clicking button 772, or canceled by clicking on button 774.

FIGS. 30 and 31 respectively show screenshots of a view with underground detail hidden and displayed. FIG. 30 shows a building such as a hospital 800, with pillars 802 at its entrance and a road 804. In the background there is a smaller building 806 and trees 808. In FIG. 31, some of the layers have been removed to reveal the footprint 810 of the hospital 800 and underground pipes 812. The smaller building 806 and pillars 802 are still visible.

General Information and Variations

The system 2 allows: ease of management of all electronic assets; enterprise-wide dissemination of relevant data; access to 2D, 3D, tabular, and spatial data from a centralized location; access via mobile devices; access independently of platform; extendable cost recovery via the ability to support resalable data subsets, with extended functionality, via consumables such as mobile applications; the aggregation of electronic information from other data sets via web services; and an excellent level of security.

The system 2 may reside on a virtual machine infrastructure. This approach provides maximum flexibility in deployment options, as well as the ability to upgrade the hardware platform with minimal impact. Testing, development, and backup are improved by working with systems that are easily replicated and can support parallel operations. Virtualization also lowers the system's total cost of ownership because hardware used for virtual servers can support many systems with different peak load times, allowing a more powerful, fault-tolerant set of hardware to be shared by many applications. In addition, using virtual machines allows the use of processing clusters to help manage demand if the system use expands.

The overall architecture may be three-tier, these being the client, or user interface, the middleware and the data layers. The server-side architecture may, for example, include a Windows™ server running Internet Information Server™ (IIS), and the .NET Framework™, which is included in all recent versions of the Windows™ operating system. The foundational application may be built primarily in ASP.NET™ using C#, and rendered as HTML, CSS, and JavaScript™ for the web browser. It may use an ESRI ArcGIS™ server. Scripting and configuration may by enabled with XML and/or Python™. Data input forms follow a specification that allow them to be easily integrated with client installations. This approach allows scalability and flexibility to creating end-user applications.

The software solution operates internally on ODBC-compatible relational databases, and can access and update multiple internal and external data sources. As appropriate, existing databases will be accessed, and new tables created to support any enhanced functions.

A common web browser and a Unity3D™ graphics engine is the only software required on the users' computers to run the primary functions, minimizing the level of effort to deploy the system to a wide range of users. The system may be loaded by typing in the web address of the application.

A client information module may be included that allows clients to login through a secure portal, and view information, lists and forms relevant to their sites, buildings, and assets. It may also store, and display, key building data from third-party BIM systems (such as FM Systems™, Tririga™, Archibus™, etc.), and stores, and display schematics. It may provide document management of a library of all related materials, and file management for access to Revit™ drawings that may be viewed online.

A client compliance monitoring module may allow users to access, maintain, and be notified of key compliance information on their assets, buildings, or sites. It may include a calendar of key dates for each asset such as lease expiry, insurance renewal, capital maintenance and amortization.

The 3D visualization component 98 may be deployed over the web. However, for maximum performance it is preferably run as a stand-alone application with all of the spatial functions ported into an extensively augmented 3D rendering engine. This enables the highest level of mesh and polygon count with maximum performance gained through compression such as view frustum, back face contribution and occlusion culling. Changes of buildings in Revit™ are reflected in the site model.

When using mobile devices to access the system 2, field personnel can add geographically tagged data to the system for future action.

Modules, components, features etc. of the architecture and/or framework may be grouped differently to the embodiments shown herein. Some may be omitted, and others added. The system may be embodied on multiple servers. Databases may be embodied on one or multiple servers. Databases may be split into multiple constituent databases. Different file types may be used. Different algorithms may be used where appropriate. Different selection, query or drawing tools may be used. Other rules about how the system operates may be incorporated, and different constraints and limits may be employed. Different permissions may be added. Assets may be monitored with respect to time. Where named software applications have been mentioned, others with equivalent relevant functionality may be substituted. As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

We claim:

1. A geographic asset management system for presenting assets in a three dimensional rendering, comprising:
one or more databases storing asset related data comprising:
details of a plurality of assets;
geographic locations of the assets;
geographic orientations of the assets; and
one or more three dimensional models each of one or more of the assets;
a server having one or more processors for controlling access to the one or more databases;
a user terminal connected to said server for requesting at least some of the asset related data; and
a geographic information system;
wherein the one or more processors are configured to cause display on the user terminal a three dimensional rendering of a landscape retrieved from the geographical information system and one or more of the three dimensional models retrieved from the one or more databases, each displayed model located and oriented in the rendering of the landscape according to its geographic coordinates and orientation.

2. The system of claim 1 wherein:
a user of said user terminal belongs to a group of one or more users and said group is one of a plurality of groups;
each group has been granted permission to access certain of the assets; and
a model is displayed conditional upon said user having been granted access thereto.

3. The system of claim 2 wherein:
said database stores details of events related to the assets; and
said server notifies one or more users of one or more of the events.

4. The system of claim 1 wherein:
storing of the three dimensional models;
rendering of the three dimensional landscape; and
displaying of the three dimensional models;
are functionalities that are provided in an optional component to a map based geographic asset management system.

5. The system of claim 4 wherein the map based geographic asset management system is configured to:
store an assignment of each asset to an organizational unit;
store definitions of one or more roles, each role being granted a permission level in respect of creating, viewing, editing or deleting assets;
store an assignment of each of one or more users to a role;
store an assignment of each user to an organizational unit; and
provide a user with access to an asset depending on the corresponding organizational unit, role and permission level.

6. The system of claim 1 further comprising one or more of:
a building information management system;
a community planning module; and
a land registry module.

7. The system of claim 1 further configured to display on the user terminal an asset that is hidden.

8. The system of claim 7 wherein the hidden asset is underground or in a wall.

9. The system of claim 7 wherein the hidden asset is displayed on the user terminal conditional upon the user terminal being located in proximity to the hidden asset.

10. The system of claim 1 configured to store historical asset related data and to display the three dimensional models according to the historical asset related data.

11. The system of claim 1 wherein at least one asset is a building and the one or more processors are also configured to cause display of a plan of a floor of the building.

12. The system of claim 11 wherein the floor has rooms that may each be stored as a room asset, the one or more processors also configured to cause display of an indication of one or more of the room assets on the plan.

13. The system of claim 12 wherein the one or more processors are further configured to cause display of a three dimensional view of a room.

14. The system of claim 13 wherein the one or more processors are further configured to cause display of an asset in said three dimensional view of a room.

15. The system of claim 1 wherein at least one asset is an existing building or a proposed building.

16. The system of claim 1 wherein the one or more databases store a terrain adjustment model and the one or more processors are also configured to cause display of the terrain adjustment model blended to the rendering of the landscape.

17. A method for presenting assets in a three dimensional model comprising:
storing, by a processor, in one or more databases, asset related data comprising:
details of a plurality of assets;
geographic locations of the assets;
geographic orientations of the assets; and
one or more three dimensional models each of one or more of the assets;
receiving, by a server, a request to access at least some of the asset related data;
transmitting, by the server, said requested asset related data to a user terminal;
displaying, on the user terminal, a three dimensional rendering of a landscape retrieved from a geographical information system; and
displaying, on the user terminal, one or more of the three dimensional models, each displayed model located and oriented in the rendering of the landscape according to its geographic coordinates and orientation.

18. The method of claim 17 further comprising:
storing, by the processor, in the one or more databases:
an assignment of each asset to an organizational unit;
definitions of one or more roles, each role being granted a permission level in respect of creating, viewing, editing or deleting assets;
an assignment of each of one or more users to a role; and
an assignment of each user to an organizational unit;
and providing, by the processor, a user with access to an asset depending on the corresponding organizational unit, role and permission level.

19. The method of claim 17 wherein an asset is one or more of:
a hidden asset;
an existing building;
a proposed building;
a floor of a building;
a room;
an item in a room;
a historical asset; and
a terrain adjustment model that, when displayed, is blended to the landscape.

20. One or more computer readable media carrying computer readable instructions, which, when executed by one or more processors cause said processors to:
store, in one or more databases, asset related data comprising:
details of a plurality of assets;
geographic locations of the assets;
geographic orientations of the assets; and
one or more three dimensional models each of one or more of the assets;
receive a request to access at least some of the asset related data;
transmit said requested asset related data to a user terminal;
display, on the user terminal, a three dimensional rendering of a landscape retrieved from a geographical information system; and
display, on the user terminal, one or more of the three dimensional models, each displayed model located and oriented in the rendering of the landscape according to its geographic coordinates and orientation.
